(19) United States
(12) Patent Application Publication
(10) Pub. No.: US 2026/0099542 A1
(43) Pub. Date: Apr. 9, 2026

(54) GENERATING CONTENT RECOMMENDATIONS WITH LANGUAGE MODEL NEURAL NETWORKS USING CONTENT ITEM CLUSTERS

(71) Applicant: Google LLC, Mountain View, CA (US)

(72) Inventors: Yifan Liu, Fremont, CA (US); Minmin Chen, Palo Alto, CA (US); Haokai Lu, Palo Alto, CA (US); Jianling Wang, Mountain View, CA (US); Ningren Han, Sunnyvale, CA (US); He Ma, Belmont, CA (US); Yueqi Wang, New York, NY (US); Ed Huai-hsin Chi, Palo Alto, CA (US); Shuchao Bi, Mountain View, CA (US)

(21) Appl. No.: 19/245,152

(22) Filed: Jun. 20, 2025

Related U.S. Application Data
(60) Provisional application No. 63/662,407, filed on Jun. 20, 2024.

(51) Int. Cl. G06F 16/735; G06F 16/75

(52) U.S. Cl. CPC G06F 16/735; G06F 16/75

(57) ABSTRACT

Methods, systems, and apparatus, including computer programs encoded on computer storage media, for generating a content item recommendation. For example, a system can receive a request for a content item recommendation for a particular user; obtain data specifying, for each of a set of one or more content items that have been interacted with by the particular user, a respective cluster of content items to which the content item belongs; select, using the respective clusters for the content items in the set, a next cluster of content items from a plurality of clusters to recommend to the particular user; and select, as content items to recommend to the particular user, one or more content items from the next cluster.

### CROSS-REFERENCE TO RELATED APPLICATION

This application claims priority to U.S. Provisional Application No. 63/662,407, filed on Jun. 20, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates recommendations of content items for users.

In particular, the system leverages content item clusters generated by a language model neural network in order to more effectively generate the content item recommendations.

The content items can be any appropriate type of content item, e.g., a video, an electronic book, a software application, a news article, a web page, a music content item, e.g., a song, a web page or other resource describing a product, and so on.

Particular embodiments of the subject matter described in this specification can be implemented so as to realize one or more of the following advantages.

Recommendation systems are indispensable throughout modern computing systems in helping users navigate the vast and ever-growing amount of content available, e.g., on the Internet. For example, video sharing platforms can make available, i.e., maintain for access by users, millions or even billions of videos on a wide variety of different topics. As another example, an electronic book store can make available millions of electronic books and other materials on a wide variety of different topics. This large amount of content and the fact that large amounts of new content is frequently added can make it impractical for users to effectively navigate the available content without making use of content items recommended by a recommendation system.

However, existing recommendation systems are often subject to a strong feedback loop that results in recommending items similar to a user's past behavior. In particular, existing recommendation systems generally infer a user's next interest based on their historical interactions. While this can be effective for short-term engagement, it limits users from discovering novel interests, leading to content fatigue and preventing users from effectively exploring the large amount of content that is likely to be available that relates to different interests of the user, i.e., relative to the interest(s) to which the content that the user has recently interacted with relates.

However, effectively introducing novel interests to users is challenging due to the vast interest space and the high uncertainty of a user's affinity to previously unseen interests given only their already “seen” or interacted with content.

Some prior systems have attempted to apply Large Language Models (LLMs) to content item recommendation.

However, deploying these approaches in real-world industrial recommendation systems remain extremely challenging as: (1) unlike domain-specific recommendation models, LLMs lack deep knowledge of the massive, and rapidly evolving item corpus on industrial-scale online platforms (e.g., a large number of videos on video sharing platforms or a large number of) ; (2) off-the-shelf LLMs are unaware of the collaborative signals from users, failing to capture domain-specific user behaviors; and (3) the latency and cost of serving LLMs per user request are prohibitively large. For example, existing systems that use LLMs to serve recommendations cannot meet the O(100 ms) response time expected by and production Query-Per-Second (QPS) required by industrial recommendation platforms, i.e., recommendation platforms that are deployed as part of real-world systems that serve content on the Internet.

To overcome the above challenges, this specification describes a hybrid hierarchical planning paradigm combining LLMs and classic recommendation for user interest exploration in large-scale recommendation systems.

At the high level of the hierarchy, considering the massive number of incoming items in the system, instead of directly predicting the next item, the specification describes using LLMs to infer the next novel interest.

At the low level of the hierarchy, to leverage classic recommendation models with strong personalization, this specification grounds these novel interests to item recommendations by “restricting” a recommendation system to items within the “clusters” defined by those novel interests. Thus, the hybrid approach leverages LLMs' reasoning and generalization capability in exploring user's novel interests effectively and at the same time bridges the knowledge gap by relying on domain-specific models for actual item recommendation.

In some cases, to further improve performance, this specification describes how to perform supervised fine-tuning (SFT) of the LLM with real-world novel user behaviors for in-domain user alignment and to enable the LLM to perform controlled generation, producing novel interest descriptions that directly match one of the pre-defined clusters.

Moreover, to address the latency issue with LLM-driven recommendations, this specification describes how to pre-compute the novel interest transitions offline with LLM bulk inference. The predictions originally made by the LLM can then be served online, i.e., in response to a given request for a content recommendation, with simple table lookup operations, enabling recommendations to be made within the latency constraints of real-world large-scale recommender systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2A is a flow diagram of an example process for generating a content item recommendation.

FIG. 2B shows an example of a prompt input provided to the language model neural network.

FIG. 3 is a flow diagram of an example process for selecting the next cluster.

FIG. 4 is a flow diagram of an example process for selecting one or more content items from the next cluster.

Like reference numbers and designations in the various drawings indicate like elements.

### DETAILED DESCRIPTION

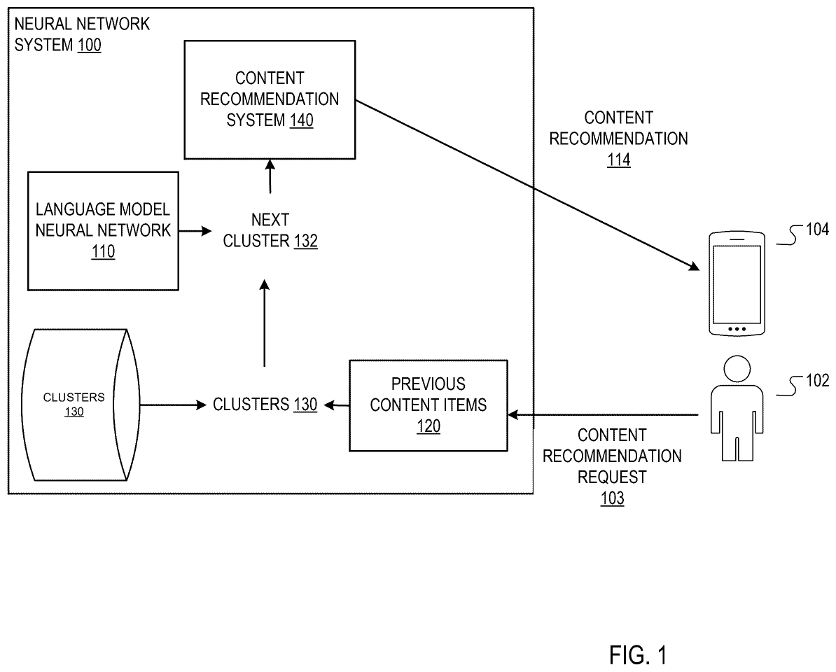

FIG. 1 shows an example neural network system 100. The neural network system 100 is an example of a system implemented as computer programs on one or more computers in one or more locations, in which the systems, components, and techniques described below can be implemented.

This system 100 generates recommendations 114 of content items for users 102. A content item “recommendation” 114, as used in this specification, is data that, when presented to a user, identifies one or more content items that can be interacted with by the user.

The content items can be any appropriate type of content item, e.g., a video, an electronic book, a software application, a news article, a web page, a music content item, e.g., a song, a web page or other resource describing a product, and so on.

The system 100 can generate the content item recommendations 114 in any appropriate context.

For example, the neural network system 100 can generate content item recommendations 114 during a conversation between the user 102 and one or more other entities, e.g., another user or a chatbot or both.

As another example, the system 100 can generate content recommendations 114 in response to search queries submitted by the user 102 to a search engine, e.g., an Internet search engine that searches web pages on the Internet, an image search engine that searches a repository of images, a video search engine that searches a repository of videos, e.g., those maintained by a video sharing platform, an app store search engine that searches a repository of software applications that are available for download, an electronic book store search engine that searches a repository of electronic books, and so on.

As another example, the neural network system 100 can generate content recommendations 114 that are presented while a user is viewing or otherwise interacting with a current content item, e.g., of content items that may be of interest to the user given that the user is viewing the current content item. For example, the user may be viewing an app in an app store (or data identifying the app) and the recommended content items can be other apps available in the app store. As another example, the user may be viewing a video available on a video sharing platform (or data identifying the video) and the recommended content items can be other videos available in the app store. As yet another example, the user may be viewing an electronic book (or data identifying an electronic book) and the recommended content items can be other available electronic books.

Generally, after the system 100 generates a recommendation 114 of a given content item, the system 100 or another system presents 130 the recommended content item to the user, e.g., on a user device 104 of the user 102. For example, the system 100 can provide the content item 112 for presentation to a user 102 or provide a search result that identifies the content item 112 and that, when selected by a user 102, causes the content item 112 to be presented to the user 102.

Generally, the system 100 receives a request 103 for a content item recommendation for a particular user 102, e.g., from the user device 104 of the user 102 or from a different system.

Rather than directly attempting to recommend a content item from a potentially extremely large set of candidate content items, the system 100 uses a hybrid hierarchical planning paradigm that combines a language model neural network 110, e.g., a large language model (LLM), and a content recommendation system 140 to allow the system 100 to efficiently perform user interest exploration even in large-scale recommendation systems.

For example, the content recommendation system 140 can be a system that uses a transformer-based sequence model, i.e., neural network, or a different type of machine learning model to generate an output that scores each of a set of content items in response to an input characterizing the context in which the content recommendation is to be made. The input characterizing the context can be received by the system 100 as part of the request 103 and can include any of, e.g., an input characterizing the particular user, the interaction history of the particular user, i.e., the content items previously interacted with by the particular user, any search queries submitted by the particular user that prompted the request 103 for the recommendation, and so on.

At the higher level of the hierarchical paradigm, considering the massive and constantly changing number of candidate content items available for recommendation by the system 100, instead of directly predicting the next item, the system 100 uses a language model neural network 110 to infer the next novel interest of the user.

At the low level, to leverage a recommendation subsystem 140 with strong personalization, the system 100 grounds these novel interests to item recommendations by “restricting” the recommendation subsystem 140 to items within the “clusters” defined by those novel interests. By combining the LLM 110 and the recommendation system 140, the hybrid approach leverages the LLM's reasoning and generalization capability in exploring the user's novel interests effectively, and at the same time bridges the knowledge gap by relying on domain-specific models for actual item recommendation.

In more detail, the system 100 obtains, e.g., as part of the request 103, data specifying a set of one or more “previous” content items 120 that have been interacted with by the particular user 102.

For example, the system 100 can select the one or more content items from an interaction history for the particular user 102 that identifies content items previously interacted with by the particular user 102.

The system 100 identifies, for each of the content items in the set and from a plurality of clusters 130 of content items, a respective cluster 130 of content items to which the content item belongs.

A “cluster” 130 of content items is a group of multiple content items that are topically coherent, i.e., that relate to the same topic. Thus, different clusters 130 of content items will be viewed by users with different interests.

The system 100 can determine the cluster to which a given content item belongs in any of a variety of ways. For example, the system 100 can receive, as part of the request 103, data that identifies which cluster some or all of the content items identified in the interaction history belong. As another example, the system 100 can process an input that characterizes the content item using a neural network, e.g., the language model neural network 110 or a different neural network, to generate a prediction of which cluster the content item should belong to. For example, the input can include the content item itself, metadata describing the content item, or both. In some examples, the input can also include a respective description of each of the content items.

Generally, the system 100 or another system can have generated the clusters 130 in any of a variety of ways that group semantically similar content items into the same cluster. A description of one example technique now follows. In this example, the clusters 130 are traffic-weighted equal sized clusters that are clustered based on their topical coherence. To create these clusters, the system 100 represents each item as an embedding vector, e.g., based on its metadata and content. For example, the system 100 can process the metadata, the content item, or both using a pre-trained embedding model to generate the embedding. Then, the system 100 connects items in a graph based on their similarity, e.g., by connecting with an edge any two content items that have embeddings that satisfy a threshold similarity, e.g., a cosine similarity or a Euclidean distance, with one another, and then cluster the graph into traffic-balanced clusters using the edges and respective “traffic” data for each content item, i.e., that identifies how many times a given data item has been interacted with by users. This clustering process is repeated multiple times to create a 4-level tree structure, with each item associated with different tree levels. Higher-level clusters represent broader topics, while lower-level clusters represent more specific ones. These clusters in each level represent different user interests, with each cluster linked to a set of keywords describing its theme. Each item belongs to a single interest cluster in each level. The system 100 can then select one of the intermediate levels, e.g., level 2 or level 3, and use the clusters at that level as the clusters 130 to balance granularity and feasible planning space.

In some cases, rather than obtaining data specifying the set of one or more previous content items 120, the system 100 can directly obtain data identifying the respective cluster 130 to which each of the one or more content items belongs. For example, the system 100 or another system may have pre-computed which clusters 130 of content items 120 the particular user 102 has interacted with.

The system 100 determines, from the respective clusters 130 for the content items in the set, a next cluster 132 of content items from the plurality clusters to recommend to the particular user.

In some implementations, the system 100 directly uses the language model neural network 110 to generate the next cluster.

In some other implementations, the system 100 has pre-computed, using the language model neural network 110, a set of mappings that each map a set of one or more previous clusters to a next cluster. In these implementations, the system 100 can use the mappings to determine the next clusters. For example, the system 100 can maintain the mapping in a tabular data structure and can perform a look-up on the tabular data structure to identify the next content item corresponding to the respective clusters 130 for the content items in the set.

Generally, the language model neural network 110 is an auto-regressive neural network that generates output sequences of tokens from a vocabulary, e.g., conditioned on a context sequence.

The neural network 110 is referred to as an auto-regressive neural network because the neural network 110 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence. For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input sequence and the current output sequence can be separated by one or more predetermined tokens within the current input sequence.

More specifically, to generate a particular token at a particular position within an output sequence, the neural network 110 can process the current input sequence to generate a score distribution, e.g., a probability distribution, that assigns a respective score, e.g., a respective probability, to each token in the vocabulary of tokens. The neural network 110 can then select, as the particular token, a token from the vocabulary using the score distribution. For example, the neural network 110 can greedily select the highest-scoring token or can sample, e.g., using nucleus sampling or another sampling technique, a token from the distribution.

As a particular example, the language model neural network 110 can be an auto-regressive Transformer-based neural network that includes (i) a plurality of attention blocks that each apply a self-attention operation and (ii) an output subnetwork that processes an output of the last attention block to generate the score distribution.

The neural network 110 can have any of a variety of Transformer-based neural network architectures. Examples of such architectures include those described in J. Hoffmann, S. Borgeaud, A. Mensch, E. Buchatskaya, T. Cai, E. Rutherford, D.d. L. Casas, L. A. Hendricks, J. Welbl, A. Clark, et al., Training compute-optimal large language models, arXiv preprint arXiv: 2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J. Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B. Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in the given input sequence at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

An “embedding,” as used in this specification is a vector of numeric values, e.g., floating point or other type of numeric values, that has a predetermined dimensionality, e.g., has a predetermined number of values.

In this example, the output subnetwork processes the output hidden state generated by the last attention block in the sequence for the last input token in the input sequence to generate the score distribution.

In other words, the language model neural network 110 is configured to map each token in the input sequence to a respective embedding and then process the embeddings through the attention blocks within the language model neural network 110 as part of generating the output.

Generally, the language model neural network 110 has been pre-trained. For example, the system 100 or another training system can have pre-trained the language model neural network 110 on a language modeling task, e.g., a task that requires predicting, given a current sequence of text tokens, the next token that follows the current sequence in the training data. As a particular example, the language model neural network 110 can be pre-trained on a next token prediction objective, i.e., a maximum-likelihood objective on a large dataset of text, e.g., text that is publicly available from the Internet or another text corpus.

In some cases, the system 100 adapts the language model neural network 110 for the task of generating cluster predictions, e.g., through fine-tuning. Fine-tuning the language model neural network 110 is described in more detail below.

Selecting the next cluster will be described in more detail below.

The system 100 selects, as content items to recommend to the particular user 102, i.e., as content items to be identified in the content recommendation 114, one or more content items from the next cluster 132. For example, the system 100 can provide an input characterizing the particular user to the content recommendation system 140 and obtain, as output from the content recommendation system 140, data specifying a set of recommended content items. The system 100 can then select, as content items to recommend to the particular user, one or more of the recommended content items that are in the next cluster 132.

That is, the output from the content recommendation system 140 generally identifies content items that belong to multiple different clusters. The system 100 can “restrict” this output by filtering output content items that do not belong to the next cluster 132 and then select from only those content items that do belong to the next cluster 132, e.g., by selecting one or more highest scoring content items from the next cluster 132.

Thus, the system 100 effectively leverages the prediction of the language model neural network 110 of the next cluster 132 to guide the output of the content recommendation system 140 to ensure that the recommended content items are likely to reflect novel interests of the particular user 102, rather than simply recommending content items that are similar to the previous content items 120 already interacted with by the particular user 102.

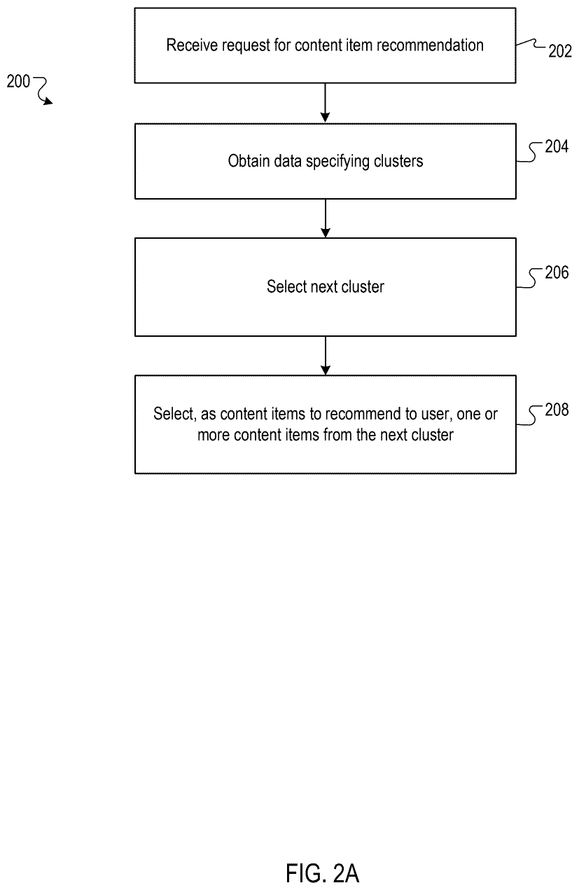

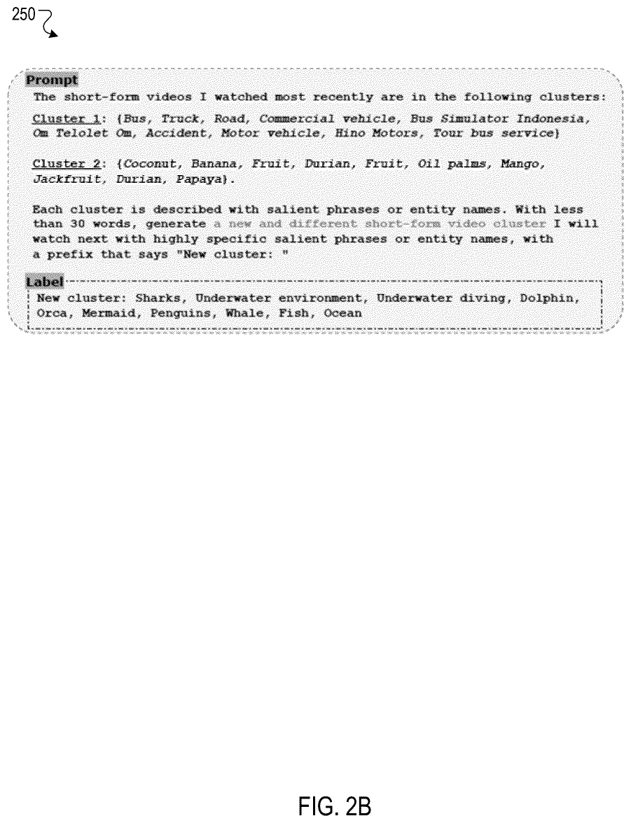

FIG. 2A is a flow diagram of an example process 200 for generating a content item recommendation. For convenience, the process 200 will be described as being performed by a system of one or more computers located in one or more locations. For example, a neural network system, e.g., the neural network system 100 of FIG. 1, appropriately programmed, can perform the process 200.

The system receives a request for a content item recommendation for a particular user (step 202).

The system obtains data specifying, for each of a set of one or more content items that have been interacted with by the particular user, a respective cluster of content items to which the content item belongs (step 204). That is, the system determines which cluster each of the one or more content items in the set belongs to.

For example, as described above, the system can select a set of one or more content items from a set of content items identified in an interaction history for the particular user and can identify the respective cluster to which each content item belongs.

In some cases, the system selects a fixed number of content items from the interaction history. For example, the system can randomly sample the fixed number of content items from the content items identified in the interaction history. As another example, the system can assign a weight to each content item in the history, e.g., based on how representative the content item is of the interaction history, based on the quality of the content item, and so on, and then sample a fixed number of content items in accordance with the weights. Sampling a fixed number of content items can increase the efficiency of querying mappings to identify a next cluster, as will be described below.

The system selects, using the respective clusters for the content items in the set, a next cluster of content items from a plurality of clusters to recommend to the particular user (step 206).

The next cluster is generally different from all of the respective clusters of the content items in the set, i.e., is a “novel” cluster that the particular user has not interacted with during the time period captured by the interaction history.

Moreover, the next cluster has been determined, by a language model neural network, to be a likely next cluster for the particular user given that the user has already interacted with the respective clusters for the content items in the set. That is, the next cluster represents a likely, as determined by the language model neural network, novel interest of the particular user that is not already captured by the respective clusters for the content items in the set.

In some implementations, the system directly uses the language model neural network to generate the next cluster. That is, the system processes an input that identifies the respective clusters using the language model neural network to generate an output that identifies the next cluster. For example, the input can also include a prompt that instructs the language model neural network to predict a cluster of data items that a user that has interacted with the respective clusters for the content items in the set would interact with next.

For example, FIG. 2B shows an example 250 of a prompt input provided to the language model neural network. In the example 250, the system is providing content item recommendations of videos, e.g., short-form videos, conditioned on videos previously interacted with by users.

As can be seen from the example 250, the prompt input identifies keywords corresponding to the respective clusters for a set of content items that includes two content items, one about a driving scenario and the other about fruit, and instructs the language model neural network to generate a new and different cluster that the user will likely interact with given that the user has interacted with the respective clusters. In the example prompt input 250, the “previous” clusters include two clusters, but in other cases, the example prompt input 250 can specify a larger number of previous clusters.

The prompt input 250 also includes a prompt that instructs the language model neural network to predict a cluster of data items that a user that has interacted with the respective clusters for the content items in the set would interact with next (“With less than 30 words, generate a new and different short-form video cluster . . . ”).

As described above, the language model neural network has generally been pre-trained prior to being used by the system. In some cases, the system fine-tunes the language model neural network, e.g., through supervised fine-tuning, to improve the controllability of the responses generated by the neural network.

In these cases, the system generates a set of training examples and trains the language model neural network on the training examples, e.g., on a next token prediction objective or using another appropriate objective function. More particularly, the training examples are specific to content recommendation.

Each cluster recommendation training example is associated with a respective user and identifies (i) an input set of one or more clusters associated with data items that have been interacted with by the respective user and (ii) a target cluster associated with a data item that was interacted with by the respective user after interacting with the data items associated with the input set of one or more clusters. Generally, the target cluster is different from any of the clusters in the input set.

For example, the system can generate the content recommendation training examples. In particular, the system can obtain a plurality of interaction histories, each interaction history corresponding to a respective user and identifying content items interacted with by the user.

For each of the plurality of clusters, the system can identify one or more of the obtained interaction histories that each include an interaction with a content item from the cluster preceded by respective interactions with one or more content items from clusters that are different from the cluster. The system can then generate a respective cluster recommendation training example from each identified interaction history. The respective cluster recommendation training example for a given identified interaction history identifies the cluster as the target cluster and the preceding clusters as the input set of clusters. By generating the examples in this manner, the system can ensure that the training data includes high-quality examples for all of the clusters.

For example, as shown in the example 250 of FIG. 2B, a given training example can include a prompt that identifies an input set of clusters, e.g., by including keywords that describe the preceding clusters, and a label that identifies the target cluster, e.g., by including keywords that describe the target cluster. In the example 250, the target cluster is a cluster that includes videos about marine life.

Performing this fine-tuning can be beneficial in several ways. For example, the fine-tuning can cause the language model neural network to perform “controlled” generation, i.e., to only predict valid clusters from the set of clusters instead of generating (“hallucinating”) descriptions of clusters that are not in the set of clusters. This can improve inference efficiency, as fewer outputs will need to be discarded because they do not match any of the clusters in the set. As another example, the fine-tuning can cause the language model neural network to more accurately predict next clusters that will actually align with the interests of users after training.

In some other implementations, whether or not the system has fine-tuned the language model neural network or makes use of a pre-trained language model neural network, the system has pre-computed, using the language model neural network, a set of mappings that each map a set of one or more previous clusters to a next cluster. In these implementations, the system can use the mappings to determine the next clusters.

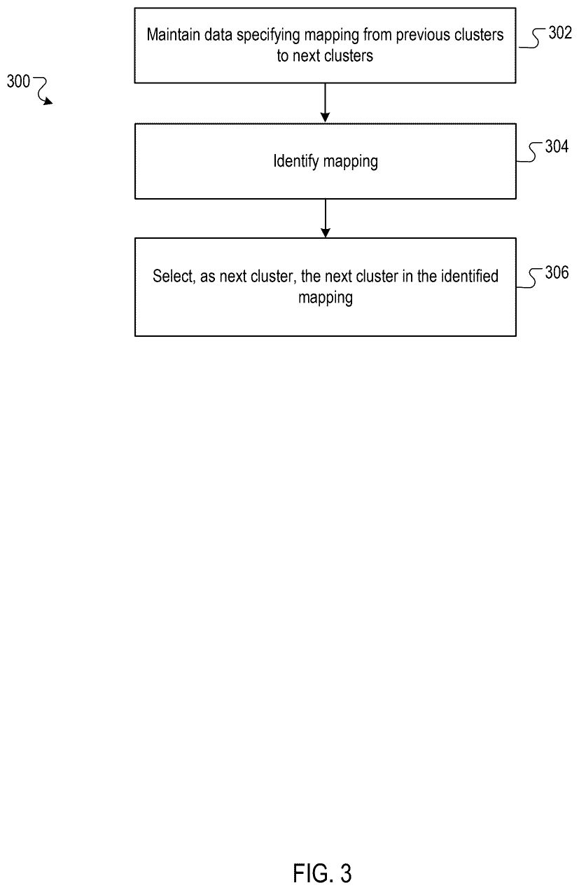

Using the mappings is described in more detail below with reference to FIG. 3.

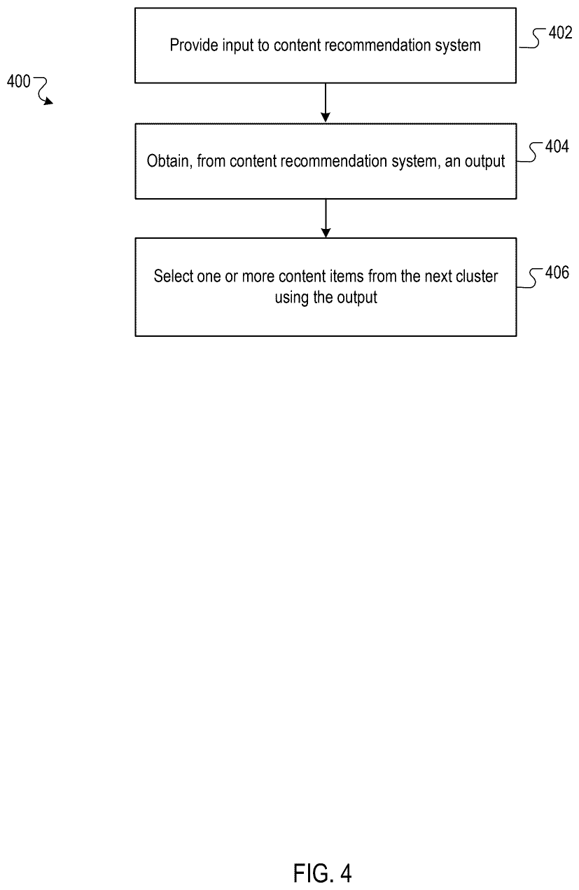

The system selects, as content items to recommend to the particular user, one or more content items from the next cluster (step 208). For example, the system can select the content items using a content recommendation system as described below with reference to FIG. 4.

FIG. 3 is a flow diagram of an example process 300 for selecting a next cluster. For convenience, the process 300 will be described as being performed by a system of one or more computers located in one or more locations. For example, a neural network system, e.g., the neural network system 100 of FIG. 1, appropriately programmed, can perform the process 300.

The system maintains data that includes a plurality of mappings (step 302).

Each mapping maps a respective set of clusters to a respective next cluster. That is, each mapping maps a set of clusters to a predicted next cluster that a user is likely to interact with given that the user interacted with the set of clusters.

For example, the system can have generated these mappings using a language model neural network.

For example, the system can generate a given mapping by processing, using the language model neural network, an input sequence that (i) identifies the respective set of clusters in the mapping and (ii) a prompt to generate an output sequence that identifies the respective next cluster in the mapping. Generally, the prompt instructs the language model neural network to predict a cluster of data items that a user that has interacted with the respective set of clusters would interact with next. For example, the prompt can be similar to the example prompt 250 described above with reference to FIG. 2B.

In particular, if the system uses K “previous” clusters when predicting a given next cluster and there are N clusters, the system can generate a respective mapping for each of the N x K possible combinations of clusters that can be included in a given input to the system. In so doing, the system ensures that a valid next cluster will be identified for any possible request that will be received by the system at run-time. As described above, in some implementations, to ensure that each request corresponds to a valid next cluster, the system can extract a fixed number of content items from each interaction history.

For example, the system can maintain the mapping in a tabular data structure and can perform a look-up on the tabular data structure to identify the next content item corresponding to the respective clusters for the content items in the set.

The system identifies, in the maintained data, a mapping that has a respective set of clusters that includes the respective clusters for the content items in the set (step 304). For example, the system can perform a look-up on the tabular data structure to identify the row in the tabular data structure that has, as values in respective columns, the respective clusters for the content items in the set, and can select, as the next content item, the content item identified in the corresponding column of the identified row.

The system selects, as the next cluster of content items to recommend to the particular user, the respective next cluster in the identified mapping (step 306).

Thus, by maintaining the mapping rather than querying the language model neural network at runtime, the system leverages the predictive capability of the language model neural network to generate the mappings and then queries the mappings when a new recommendation request is received, decreasing the latency required to generate a recommendation. That is, the system can leverage the predictive power of the language model neural network while at inference time simply performing a look-up to identify the next cluster.

FIG. 4 is a flow diagram of an example process 400 for selecting one or more content items from the next cluster. For convenience, the process 400 will be described as being performed by a system of one or more computers located in one or more locations. For example, a neural network system, e.g., the neural network system 100 of FIG. 1, appropriately programmed, can perform the process 400.

The system provides an input characterizing the context in which the content recommendation is to be made to a content recommendation system (step 402). For example, the system can obtain the input as part of the content recommendation request or can generate the input from the data in the content recommendation request.

The input can include any appropriate data that characterizes the context in which the content recommendation is to be made. For example, the input can include any of, e.g., an input characterizing the particular user, the interaction history of the particular user, i.e., data identifying the content items previously interacted with by the particular user, any search queries submitted by the particular user that prompted the request for the recommendation, and so on.

The system obtains, as output from the content recommendation system, data specifying a set of recommended content items (step 404).

For example, the content recommendation system can be a domain-specific recommendation model that uses a trained machine learning model to process an input that includes data characterizing a particular user and generates an output that defines a content item recommendation for the particular user. For example, the output can be a score distribution that assigns a respective score to each content item in a set of content items that are available to the system for recommendation.

As a particular example, the content recommendation system can be a system that uses a transformer-based sequence model, i.e., neural network, or a different type of machine learning model to generate an output that scores each of a set of content items in response to an input characterizing the context in which the content recommendation is to be made, e.g., an input characterizing the particular user, the interaction history of the particular user, any search queries submitted by the particular user that prompted the request for the recommendation, and so on.

The system selects, as content items to recommend to the particular user, one or more of the recommended content items that are in the next cluster (step 406).

For example, the system can identify which content items in the set are in the next cluster and then select the one or more content items from the next cluster that have the highest scores according to the output of the content recommendation system.

In some implementations, the system “restricts” the content recommendation system to only score the content items that belong to the next cluster instead of generating scores for all of the content items. In some other implementations, the system “restricts” the content recommendation system by filtering the output to remove the scores for the content items that are not in the next cluster.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers.

The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request for a content item recommendation for a particular user;
obtaining data specifying, for each of a set of one or more content items that have been interacted with by the particular user, a respective cluster of content items to which the content item belongs;
selecting, using the respective clusters for the content items in the set, a next cluster of content items from a plurality of clusters to recommend to the particular user; and
selecting, as content items to recommend to the particular user, one or more content items from the next cluster.

2. The method of claim 1, further comprising:
maintaining data comprising a plurality of mappings, wherein each mapping maps a respective set of clusters to a respective next cluster, and wherein selecting the next cluster of content items to recommend to the particular user comprises:
identifying, in the maintained data, a mapping that has a respective set of clusters that includes the respective clusters for the content items in the set; and
selecting, as the next cluster of content items to recommend to the particular user, the respective next cluster in the identified mapping.

3. The method of claim 2, further comprising:
generating each of the plurality of mappings in the maintained data, comprising, for each mapping:
processing, using a language model neural network, an input sequence that (i) identifies the respective set of clusters in the mapping and (ii) a prompt to generate an output sequence that identifies the respective next cluster in the mapping, wherein the prompt instructs the language model neural network to predict a cluster of data items that a user that has interacted with the respective set of clusters would interact with next.

4. The method of claim 1, wherein selecting the next cluster of content items to recommend to the particular user comprises:
processing, using a language model neural network, an input sequence that (i) identifies the respective clusters for the content items in the set and (ii) a prompt to generate an output sequence that identifies the next cluster, wherein the prompt instructs the language model neural network to predict a cluster of data items that a user that has interacted with the respective clusters for the content items in the set would interact with next.

5. The method of claim 1, wherein obtaining data specifying, for each of a set of one or more content items that have been interacted with by the particular user, a respective cluster of content items to which the content item belongs comprises:
obtaining data specifying an interaction history for the particular user; and
selecting a fixed number of clusters from the interaction history.

6. The method of claim 1, wherein selecting, as content items to recommend to the particular user, one or more content items from the next cluster comprises:
providing an input characterizing the particular user to a content recommendation system;
obtaining, as output from the content recommendation system, data specifying a set of recommended content items; and
selecting, as content items to recommend to the particular user, one or more of the recommended content items that are in the next cluster.

7. The method of claim 6, wherein the data specifying a set of recommended content items comprises a respective score for each of the recommended content items and wherein selecting, as content items to recommend to the particular user, one or more of the recommended content items that are in the next cluster comprises:
selecting, from the recommended content items that are in the next cluster, one or more highest scoring recommended content items.

8. The method of claim 4, wherein the language model neural network is a pre-trained language model neural network that has been fine-tuned on cluster recommendation training examples, each cluster recommendation training example being associated with a respective user and identifying (i) an input set of one or more clusters associated with data items that have been interacted with by the respective user and (ii) a target cluster associated with a data item that was interacted with by the respective user after interacting with the data items associated with the input set of one or more clusters.

9. The method of claim 8, further comprising:
generating the cluster recommendation training examples, comprising:
obtaining a plurality of interaction histories, each interaction history corresponding to a respective user;
for each of the plurality of clusters:
identifying one or more interaction histories that each include an interaction with a content item from the cluster preceded by respective interactions with one or more content items from clusters that are different from the cluster; and
generating a respective cluster recommendation training example from each identified interaction history.

10. The method of claim 1, wherein obtaining data specifying, for each of a set of one or more content items that have been interacted with by the particular user, a respective cluster of content items to which the content item belongs comprises:
obtaining data specifying the set of one or more content items that have been interacted with by the particular user; and
identifying, for each of the content items in the set and from the plurality of clusters of content items, a respective cluster of content items to which the content item belongs.

11. The method of claim 1, wherein the one or more content items to recommend to the particular user are videos maintained by a video sharing platform.

12. A system comprising one or more computers and one or more storage devices storing instruction that when executed by the one or more computers cause the one or more computers to perform operations comprising:
receiving a request for a content item recommendation for a particular user;
obtaining data specifying, for each of a set of one or more content items that have been interacted with by the particular user, a respective cluster of content items to which the content item belongs;
selecting, using the respective clusters for the content items in the set, a next cluster of content items from a plurality of clusters to recommend to the particular user; and
selecting, as content items to recommend to the particular user, one or more content items from the next cluster.

13. The system of claim 12, the operations further comprising:
maintaining data comprising a plurality of mappings, wherein each mapping maps a respective set of clusters to a respective next cluster, and wherein selecting the next cluster of content items to recommend to the particular user comprises:
identifying, in the maintained data, a mapping that has a respective set of clusters that includes the respective clusters for the content items in the set; and
selecting, as the next cluster of content items to recommend to the particular user, the respective next cluster in the identified mapping.

14. The system of claim 13, the operations further comprising:
generating each of the plurality of mappings in the maintained data, comprising, for each mapping:
processing, using a language model neural network, an input sequence that (i) identifies the respective set of clusters in the mapping and (ii) a prompt to generate an output sequence that identifies the respective next cluster in the mapping, wherein the prompt instructs the language model neural network to predict a cluster of data items that a user that has interacted with the respective set of clusters would interact with next.

15. The system of claim 12, wherein selecting the next cluster of content items to recommend to the particular user comprises:
processing, using a language model neural network, an input sequence that (i) identifies the respective clusters for the content items in the set and (ii) a prompt to generate an output sequence that identifies the next cluster, wherein the prompt instructs the language model neural network to predict a cluster of data items that a user that has interacted with the respective clusters for the content items in the set would interact with next.

16. The system of claim 12, wherein obtaining data specifying, for each of a set of one or more content items that have been interacted with by the particular user, a respective cluster of content items to which the content item belongs comprises:
obtaining data specifying an interaction history for the particular user; and
selecting a fixed number of clusters from the interaction history.

17. The system of claim 12, wherein selecting, as content items to recommend to the particular user, one or more content items from the next cluster comprises:
providing an input characterizing the particular user to a content recommendation system;
obtaining, as output from the content recommendation system, data specifying a set of recommended content items; and
selecting, as content items to recommend to the particular user, one or more of the recommended content items that are in the next cluster.

18. The system of claim 17, wherein the data specifying a set of recommended content items comprises a respective score for each of the recommended content items and wherein selecting, as content items to recommend to the particular user, one or more of the recommended content items that are in the next cluster comprises:
selecting, from the recommended content items that are in the next cluster, one or more highest scoring recommended content items.

19. The system of claim 16, wherein the language model neural network is a pre-trained language model neural network that has been fine-tuned on cluster recommendation training examples, each cluster recommendation training example being associated with a respective user and identifying (i) an input set of one or more clusters associated with data items that have been interacted with by the respective user and (ii) a target cluster associated with a data item that was interacted with by the respective user after interacting with the data items associated with the input set of one or more clusters.

20. One or more non-transitory computer storage media storing instruction that when executed by the one or more computers cause the one or more computers to perform operations comprising:
receiving a request for a content item recommendation for a particular user;
obtaining data specifying, for each of a set of one or more content items that have been interacted with by the particular user, a respective cluster of content items to which the content item belongs;
selecting, using the respective clusters for the content items in the set, a next cluster of content items from a plurality of clusters to recommend to the particular user; and
selecting, as content items to recommend to the particular user, one or more content items from the next cluster.
